(19) United States
(12) Patent Application Publication
(10) Pub. No.: US 2004/0078756 A1
(43) Pub. Date: Apr. 22, 2004

(54) Method of improving recognition accuracy in form-based data entry systems

(76) Inventors: Jonathon Leigh Napper, Balmain (AU); Paul Lapstun, Balmain (AU)

Correspondence Address: SILVERBROOK RESEARCH PTY LTD, 393 DARLING STREET, BALMAIN, 2041, AU

(21) Appl. No.: 10/683,151

(22) Filed: Oct. 14, 2003

(30) Foreign Application Priority Data
Oct. 15, 2002 (AU) 2002952106

(51) Int. Cl. G06F 17/00

(52) U.S. Cl. 715/507

(57) ABSTRACT

The invention provides a method of interpreting data input to a form-based data entry system, including decoding data entered into a particular form field such that its information content can be determined, said information content being in a consistent machine-readable format, wherein said decoding of data includes determining one or more possible values of information content, certain pre-defined possible outcomes being given a relatively higher probability of being correct, and said pre-defined possible outcomes being dependent on the context of the particular form field.

The present invention relates to methods of improving recognition accuracy in the area of interpreting data entered into a form-based data entry system.

### BACKGROUND OF THE INVENTION

Many different systems require a user to interact and to provide data via one or more different means. On-line systems include those found on Internet web pages, and off-line systems include hand-written form creation where the hand-written forms are later scanned and interpreted by a suitable apparatus. Other on-line systems include voice recognition systems where a user is prompted to speak in response to a particular prompt.

Problems with such data input systems, also known as natural language systems, include noise and ambiguity, with different users speaking, writing or otherwise entering data in an inconsistent manner.

### CROSS-REFERENCES

Various methods, systems and apparatus relating to the present invention are disclosed in the following co-pending applications filed by the applicant or assignee of the present invention. The disclosures of all of these co-pending applications are incorporated herein by cross-reference.

5 Oct. 2002: Australian Provisional Application 2002952259 “Methods and Apparatus (NPT019)”.

15 Oct. 2002: PCT/AU02/01391, PCT/AU02/01392, PCT/AU02/01393, PCT/AU02/01394 and PCT/AU02/01395.

26 Nov. 2001: PCT/AU01/01527, PCT/AU01/01528, PCT/AU01/01529, PCT/AU01/01530 and PCT/AU01/01531.

11 Oct. 2001: PCT/AU01/01274.

14 Aug. 2001: PCT/AU01/00996.

27 Nov. 2000: PCT/AU00/01442, PCT/AU00/01444, PCT/AU00/01446, PCT/AU00/01445, PCT/AU00/01450, PCT/AU00/01453, PCT/AU00/01448, PCT/AU00/01447, PCT/AU00/01459, PCT/AU00/01451, PCT/AU00/01454, PCT/AU00/01452, PCT/AU00/01443, PCT/AU00/01455, PCT/AU00/01456, PCT/AU00/01457, PCT/AU00/01458 and PCT/AU00/01449.

20 Oct. 2000: PCT/AU00/01273, PCT/AU00/01279, PCT/AU00/01288, PCT/AU00/01282, PCT/AU00/01276, PCT/AU00/01280, PCT/AU00/01274, PCT/AU00/01289, PCT/AU00/01275, PCT/AU00/01277, PCT/AU00/01286, PCT/AU00/01281, PCT/AU00/01278, PCT/AU00/01287, PCT/AU00/01285, PCT/AU00/01284 and PCT/AU00/01283.

15 Sep. 2000: PCT/AU00/01108, PCT/AU00/01110 and PCT/AU00/01111.

30 Jun. 2000: PCT/AU00/00762, PCT/AU00/00763, PCT/AU00/00761, PCT/AU00/00760, PCT/AU00/00759, PCT/AU00/00758, PCT/AU00/00764, PCT/AU00/00765, PCT/AU00/00766, PCT/AU00/00767, PCT/AU00/00768, PCT/AU00/00773, PCT/AU00/00774, PCT/AU00/00775, PCT/AU00/00776, PCT/AU00/00777, PCT/AU00/00770, PCT/AU00/00769, PCT/AU00/00771, PCT/AU00/00772, PCT/AU00/00754, PCT/AU00/00755, PCT/AU00/00756 and PCT/AU00/00757.

24 May 2000: PCT/AU00/00518, PCT/AU00/00519, PCT/AU00/00520, PCT/AU00/00521, PCT/AU00/00522, PCT/AU00/00523, PCT/AU00/00524, PCT/AU00/00525, PCT/AU00/00526, PCT/AU00/00527, PCT/AU00/00528, PCT/AU00/00529, PCT/AU00/00530, PCT/AU00/00531, PCT/AU00/00532, PCT/AU00/00533, PCT/AU00/00534, PCT/AU00/00535, PCT/AU00/00536, PCT/AU00/00537, PCT/AU00/00538, PCT/AU00/00539, PCT/AU00/00540, PCT/AU00/00541, PCT/AU00/00542, PCT/AU00/00543, PCT/AU00/00544, PCT/AU00/00545, PCT/AU00/00547, PCT/AU00/00546, PCT/AU00/00554, PCT/AU00/00556, PCT/AU00/00557, PCT/AU00/00558, PCT/AU00/00559, PCT/AU00/00560, PCT/AU00/00561, PCT/AU00/00562, PCT/AU00/00563, PCT/AU00/00564, PCT/AU00/00565, PCT/AU00/00566, PCT/AU00/00567, PCT/AU00/00568, PCT/AU00/00569, PCT/AU00/00570, PCT/AU00/00571, PCT/AU00/00572, PCT/AU00/00573, PCT/AU00/00574, PCT/AU00/00575, PCT/AU00/00576, PCT/AU00/00577, PCT/AU00/00578, PCT/AU00/00579, PCT/AU00/00581, PCT/AU00/00580, PCT/AU00/00582, PCT/AU00/00587, PCT/AU00/00588, PCT/AU00/00589, PCT/AU00/00583, PCT/AU00/00593, PCT/AU00/00590, PCT/AU00/00591, PCT/AU00/00592, PCT/AU00/00594, PCT/AU00/00595, PCT/AU00/00596, PCT/AU00/00597, PCT/AU00/00598, PCT/AU00/00516, PCT/AU00/00517 and PCT/AU00/00511.

### DESCRIPTION OF THE PRIOR ART

U.S. Pat. No. 5,237,628 describes an optical recognition system that is able to recognise machine printed, but not hand written characters, to locate the form fields in the digital image by locating the machine printed field identifiers. Once a field has been identified, offline handwritten character recognition is used to recognise individual characters in each field.

U.S. Pat. No. 5,455,872 discloses a field based recognition system which is able to select the optimum type of classifier (e.g. constrained handprint, unconstrained handprint, unconstrained cursive writing) for use with a particular field in a form. The system uses an adaptive weighting system and confidence values to determine the best classifier to use.

U.S. Pat. No. 5,235,654 describes a system which incorporates form definition capabilities with a character recognition processor.

SiberSytems offer a product utilising a form definition language that uses Artificial Intelligence techniques to deduce different field types that appear on a form.

### SUMMARY OF THE PRESENT INVENTION

In a broad form, the present invention provides a method of interpreting data input to a form-based data entry system, including decoding data entered into a particular form field such that its information content can be determined, said information content being in a consistent machine-readable format, wherein said decoding of data includes determining one or more possible values of information content, certain pre-defined possible outcomes being given a relatively higher probability of being correct, and said pre-defined possible outcomes being dependent on the context of the particular form field.

Preferably, said decoding of data is performed on written or voice data.

Said decoding may be performed online, where the decode takes place contemporaneously with the data entry, or offline, where the decode takes place some time after data entry.

Preferably, a particular form field has associated with it a predefined dictionary of possible decoded data, and said dictionary may be used to constrain the decode process such that a particular decode either has to reside in the dictionary, or that there should at least be a certain probability that it does.

Preferably, certain possible decodes can be given a higher probability of being correct. An example of this might be a name field, where Smith has a higher chance of being the correct decode than Smithfield.

Embodiments of the present invention offer advantages in that more successful recognition of data input can be achieved in natural language systems by decoding the data input based on the context of the field in which the data is entered.

### BRIEF DESCRIPTION OF THE DRAWINGS

For a better understanding of the present invention and to understand how the same may be brought into effect, the invention will now be described by way of example only, with reference to the appended drawings in which:

FIG. 1 shows a typical form having two input fields;

FIG. 2 shows another typical form having two different input fields; and

FIGS. 3a and 3b shows two different but similar handwriting samples.

### DETAILED DESCRIPTION OF THE PREFERRED EMBODIMENTS

In the preferred embodiment, the invention is configured to work with the Netpage networked computer system, a detailed description of which is given in our co-pending applications, including in particular PCT application WO0242989 entitled “Sensing Device” filed 30 May 2002, PCT application WO0242894 entitled “Interactive Printer” filed 30 May 2002, PCT application WO0214075 “Interface Surface Printer Using Invisible Ink” filed 21 Feb. 2002, PCT application WO0242950 “Apparatus For Interaction With A Network Computer System” filed 30 May 2002, and PCT application WO03034276 entitled “Digital Ink Database Searching Using Handwriting Feature Synthesis” filed 24 Apr. 2003. It will be appreciated that not every implementation will necessarily embody all or even most of the specific details and extensions described in these applications in relation to the basic system. However, the system is described in its most complete form to assist in understanding the context in which the preferred embodiments and aspects of the present invention operate.

In brief summary, the preferred form of the Netpage system provides an interactive paper-based interface to online information by utilizing pages of invisibly coded paper and an optically imaging pen. Each page generated by the Netpage system is uniquely identified and stored on a network server, and all user interaction with the paper using the Netpage pen is captured, interpreted, and stored. Digital printing technology facilitates the on-demand printing of Netpage documents, allowing interactive applications to be developed. The Netpage printer, pen, and network infrastructure provide a paper-based alternative to traditional screen-based applications and online publishing services, and supports user-interface functionality such as hypertext navigation and form input.

Typically, a printer receives a document from a publisher or application provider via a broadband connection, which is printed with an invisible pattern of infrared tags that each encodes the location of the tag on the page and a unique page identifier. As a user writes on the page, the imaging pen decodes these tags and converts the motion of the pen into digital ink. The digital ink is transmitted over a wireless channel to a relay base station, and then sent to the network for processing and storage. The system uses a stored description of the page to interpret the digital ink, and performs the requested actions by interacting with an application.

Applications provide content to the user by publishing documents, and process the digital ink interactions submitted by the user. Typically, an application generates one or more interactive pages in response to user input, which are transmitted to the network to be stored, rendered, and finally printed as output to the user. The Netpage system allows sophisticated applications to be developed by providing services for document publishing, rendering, and delivery, authenticated transactions and secure payments, handwriting recognition and digital ink searching, and user validation using biometric techniques such as signature verification.

Embodiments of the present invention are operable in either on-line or off-line situations to decode natural language input data. Such input data can take the form of handwriting, spoken words or other non-constrained forms of input.

For the purposes of this description, ‘on-line’ refers to systems where the input data is decoded in real-time, i.e. contemporaneously with the input of the data. In other words, the decoding process is able to work with dynamic information, such as the trajectory of the various strokes which make up a written character. A typical on-line system is an Internet web page, where the input is accepted, for instance, in the form of handwritten characters entered via means of a stylus and a suitable graphics tablet.

For the purposes of this description, ‘off-line’ refers to systems where the input data is recorded, but the decoding does not occur until some time later. In other words, the decoding is only able to work with a static representation of the input, such as a bitmap image of a written character. A typical off-line system is a handwritten form data capture system where a user completes a form using handwriting and regular pen, and at a later time, the completed form is scanned and processed to extract the data encoded therein.

As has been noted, the use of natural language input systems poses a number of problems for system designers. There is a great range of different writing styles, both from person to person, and even for the same person on different occasions or using different writing implements. Likewise, there is a wide variety of accents, intonations, dialects and pitches of voices, each making it difficult to distinguish voice input from different speakers.

Embodiments of the present invention provide a method for improving recognition accuracy in a variety of natural language data input systems. The improvement is achieved by constraining the set of possible data which may be entered in a particular field, based on certain attributes of the field itself. In one embodiment, the constraint may be absolute, in that the data entered in the field must be found in a defined set of data associated with that field.

In other embodiments, the constraint may be partial, in that a greater weighting is given to data input which is found in a defined set of data. In these cases, if a data entry is decoded and found not to reside in the list of higher-weighted outcomes, it is still accepted, whereas in the previous embodiment, such a result would be discounted.

In a form-based data entry system, the form includes one or more fields, each of which is able to receive a data entry. In the following description, for convenience, embodiments of the invention will primarily described in terms of a system arranged to receive handwritten input, but the skilled man will realise that other forms of data input, such as speech, can also benefit from embodiments of the invention.

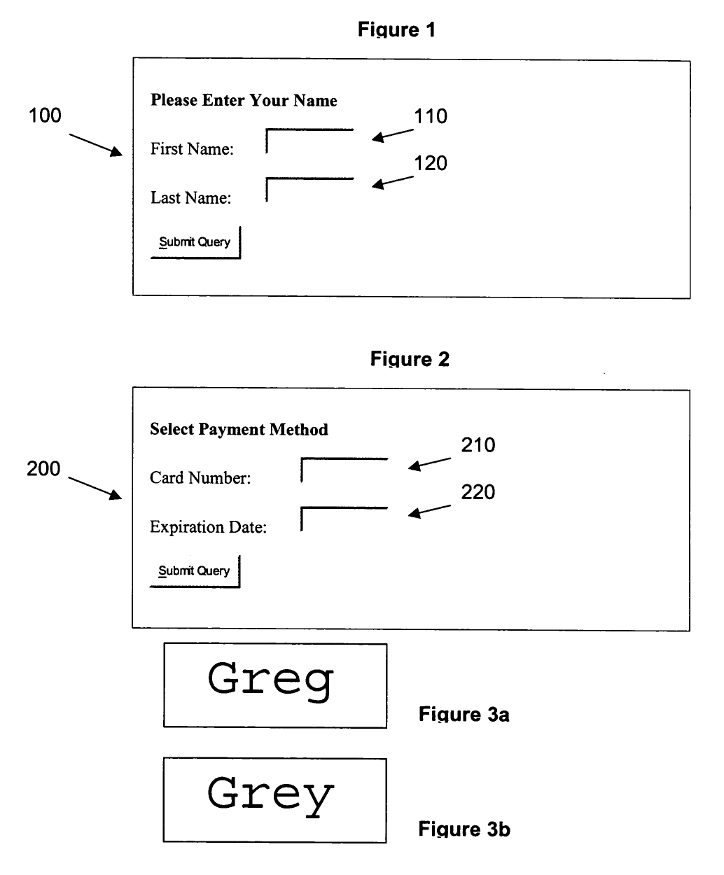

FIG. 1 shows a typical form 100 which is intended to capture name information from two separate fields 110, 120. The field 110 labelled ‘First Name’ is provided to capture an input from a user giving his first name. The second field 120, labelled ‘Last Name’ is provided to capture an input from a user giving his last name.

In the first case, the associated processing system, whether on-line or off-line, is able to decode the input data, and constrain the likely results on the basis of information implicit in the field label, ‘First Name’. The processing system is provided with a database of common first names such that when the handwritten input is decoded, a greater weighting is given to possible values of the decoded input which reside in the database of common first names. As an example, a particular user may be called ‘Greg’. However, in his particular writing style, his name may appear to resemble ‘Grey’.

FIG. 3a shows a graphic representation of a user's rendering of his first name in a form field. FIG. 3b shows how the same user would render the word ‘Grey’, and it is noticeable that the two representations are very similar, and differ only in the closed upper portion of the final letter ‘g’ in ‘Greg’ when compared to the ‘y’ of ‘Grey’.

When the processing system seeks to decode and interpret the written input, a greater weighting is given to ‘Greg’, as this is far more likely to be a valid first name. Note that in this case, ‘Grey’ is a word which is to be found in a dictionary of acceptable words, but is unlikely to feature in a list of common first names. In this way, constraining the data by giving preference to common names over other valid words has produced the correct result. In other cases, where two or more results are likely and all appear in the constrained list, the user may be prompted to re-enter the data, or be presented with an option to choose the correct one of the possible results from a list of the probable results.

The same process can be adapted for different fields likely to be found in different forms. The non-exhaustive exemplary list below details several fields and the kinds of constraints which may be applied to the decoding process to improve the likelihood of generating the correct outcome from a given input. The ordinary skilled person will, of course, realise that different fields may have contextual constraints applied to them according to their particular properties.

| Field Label String | Context Processing |
|---|---|
| First Name, Given Name, etc. | Large lists of common first names are widely and |
| | publicly available for use as dictionaries defining |
| | processing constraints during recognition. These lists, |
| | which are often derived from census data, include |
| | associated a-priori probabilities, allowing common |
| | names such as “John” and “David” to be more |
| | frequently matched. If additional information from the |
| | form or elsewhere is available that indicates the gender |
| | of the writer, separate male and female lists can be used |
| | to further improve recognition accuracy. |
| | Note that during recognition, out-of-vocabulary words |
| | (i.e. names that do not appear in the name dictionary) |
| | can be allowed to ensure that unusual and uniquely |
| | spelled names can still be recognised correctly. This |
| | can be done by combining the dictionary decoding with |
| | a probabilistic grammar model (such as an character n- |
| | gram) that contains information regarding the a-priori |
| | probability of character sequences usually found in |
| | names. |
| Last Name, Surname, Family | Similar to the above field, but using a dictionary of last |
| Name, etc. | names. Note that for Western names, there is generally |
| | much greater variability of last names across the |
| | population, so the probability of out-of-vocabulary |
| | words must be higher than that for first name |
| | recognition. |
| Address | Most addresses follow a regular pattern (e.g. dwelling |
| | number, followed by street name and street type). The |
| | recognition system can exploit this pattern during |
| | decoding by, for example, using regular expression |
| | matching, or by altering the valid character set (i.e. |
| | digits only, letters only, ‘/’ allowed or not allowed, etc.) |
| | as recognition proceeds. |
| | In addition to this, some elements in the address can be |
| | decoded with the assistance of a dictionary, such as |
| | street type (“Street”, “Road”, “Place”, “Avenue”, |
| | “Crescent”, “Square”, “Hill” etc.) or street names |
| | (common street names include “Main”, “Church”, |
| | “North”, “High”, etc.) |
| Suburb, Town, etc. | Full lists of suburbs and towns are freely and publicly |
| | available for most regions. This information can be |
| | used in conjunction with other information such as state |
| | or postcode/zipcode information (if available) to |
| | further reduce the recognition alternatives. |
| | For instance, if it has already been established that the |
| | country of residence is e.g. Australia, then there are |
| | only seven possible values for the next hierarchical |
| | division of state or territory. Once that field has been |
| | decoded, a further constraining dictionary of suburbs or |
| | towns in that state/territory can be used to imit the |
| | possible outcomes. |
| State | Lists of states are available if the Country/Region is |
| | known. Each state can be given an a-priori probability |
| | corresponding in the likelihood that a person is from |
| | that state (i.e. large, populous states can be given a |
| | higher a-priori probability). Further constrains can be |
| | used if postcode/zipcode is known. |
| Phone Number | Phone numbers follow a regular pattern (e.g. “(##) |
| | ####-####”) that can be used during recognition. |
| | Additionally, the valid character set for a phone number |
| | is constrained to numbers only, further restricting the |
| | potential recognition alternatives. |
| Zip/Postal Code | Zip/Postal codes within a given country generally |
| | follow a specific pattern. For example: in Australia, the |
| | postal codes are always four digits long; in the USA, |
| | five digits; and in the UK, a mix of one or more letters, |
| | followed by two or more numbers, followed by one or |
| | more letters again. Additional decoding constraints are |
| | available if the corresponding State and Suburb |
| | information is available. |
| Country, Region, etc. | Full lists of possible Country/Region labels are publicly |
| | available. |
| Birth Date, Date of Birth, | Written dates generally follow a regular pattern, and |
| Other dates etc. | have a constrained character set consisting of either |
| | numbers alone or numbers and delimiting characters |
| | such as ‘-’ or ‘/’. |
| Email, E-Mail, Email | Email addresses follow a specific pattern and have a |
| Address, etc. | well-specified character set. An example regular |
| | expression that can be used to match email addresses is |
| | “/\hat{ }([a-zA-Z0-9_\.\-])+\@(([a-zA-Z0-9\-])+\.)+([a-zA- |
| | Z0-9])+$/”. |
| | In addition to this, if email contact information is |
| | available for a user (e.g. using Microsoft Windows |
| | Messaging API (MAPI)), the list of email addresses can |
| | be used as a dictionary during recognition. Similarly, |
| | common email domain names (e.g. “hotmail.com”, |
| | “yahoo.com”, “email.com”, etc.) can be used as |
| | dictionary entries to guide recognition. |
| Credit Card, Credit Card | Credit card numbers have a specific format (e.g. “####- |
| Number, etc. | ####-####-####”) and constrained character set. |
| | Additionally, there are often validation rules (e.g. check |
| | digit tests) that can also be used during recognition. For |
| | example, if there are two equi-probable results for the |
| | recognition of a credit-card number, check digit |
| | validation may be of helpful in selecting the correct |
| | result. |
| Language/Locale | Lists of languages that are spoken around the world are |
| | freely available, and are currently used by many web |
| | forms. Once the language of a particular writer is |
| | known, it can be used to improve the processing of |
| | other types of input. Examples of this include different |
| | language-specific dictionaries (e.g. English, German, |
| | French, etc.) for text recognition, changing the valid |
| | recognition character set (e.g. allowing accented letters |
| | that are used by some Western European languages), |
| | and changing the format for date recognition. |

In addition to using publicly available or proprietary dictionaries, particular field labels may compile their own dictionaries over time, using previously recognised responses to guide and constrain future data entries. In this way, systems employing embodiments of the invention can improve their recognition capabilities as they operate over time and ‘learn’ more possible outcomes of the decode process. In this way, names which become more popular over time, for instance, can be given a higher a priori weighting.

Most form definition formats support a number of different field types, such as text fields, selection list fields, combination fields (i.e. a field that combines text input with a selection list), signature fields, checkboxes, buttons, and so on. The field type gives some indication of the expected input data-type (e.g. a text input field indicates text entry). If a document format allows data-types to be explicitly defined (e.g. XML/XForms), a recognition system can use this information to constrain the recognition process.

In addition to the field type, forms often contain information regarding the type of data that should be entered in each field. This information is usually contained in attributes that are associated with a specific field. One example of this is the set of selection strings that are commonly associated with list input fields. These strings represent the options from which the user must make a selection, and can be used as dictionary elements during recognition. Similarly, recognition of combination fields can use a dictionary of selection strings in combination with a character grammar to allow words other than those listed in the option list to be recognized.

Standard input fields may also contain attributes that can assist in the recognition procedure. For example, some input field types have a flag indicating that the value entered must be numeric, signifying to the recognition system that the recognised character set should only include digits. Input fields may also contain a mask attribute, which is a string indicating that the input must match the specified pattern (e.g. “####AA” requiring that four digits followed by two upper-case alphabetic letters be entered such as “2002CY”). This mask can be used to constrain the valid recognition character set at each offset in the string and thus improve the recognition accuracy.

Many forms specify validation parameters that can be used to guide the recognition process. For example, numeric input fields may specify minimum and maximum values that can be used to constrain the recognition results. Other fields may contain validation program code (e.g. JavaScript) that is executed when the user has entered a value into the field. This code can be executed multiple times, with each individual recognition result as a parameter, allowing potential alternative results that do not conform to the validation requirements to be discarded.

In addition to using standard form field attributes to improve the recognition process, recognition-specific information can be added to fields using custom attributes. This information is only used if the form input is processed using a recognition system. Thus, the form can still be used normally where required (e.g. data entry using a keyboard via a web browser) since the custom attributes are ignored; however, if recognition is required, the custom parameters can be used to improve the recognition results.

Some examples of custom field attributes include character set definition (where the set of valid characters for a field is explicitly defined) and regular expressions. If the fields are displayed or printed using visual cues to guide character spacing (e.g. boxes on forms where each box must contain a single character), the parameters of the guide can be associated with the field as custom attributes to assist with the character segmentation stage of the handwriting recognition. For example, by specifying the coordinates of the bounding rectangle and the number of rows and columns in a field that uses character boxes for input, the recognition system can be informed of the expected location of each character, allowing more accurate recognition to occur.

Information regarding context processing and language modelling can also be encoded in custom attributes. Some handwriting recognition systems use a combination of language models to assist in the recognition of handwritten text (e.g. n-gram character models, standard dictionaries, user-specific dictionaries). These models are usually combined using a set of weightings that indicate the likelihood that an input word will be decoded correctly using each of the specified models. However, the most accurate results are produced when the weightings can be customised depending on the expected input. By including the language model weights as a custom attribute for a field, more accurate recognition can be achieved by tuning the model weights on a per form or even per field basis.

To allow more control over the recognition procedure, custom validation program code (e.g. JavaScript) can be associated with a field that is executed on each potential result after the handwriting recognition procedure has completed, allowing the most appropriate result to be selected. However, rather than using a Boolean validation function (i.e. a string is either valid or invalid), the function can return a confidence value that indicates the probability that the string would be entered. This probability can be combined with the results of the character classification procedure to select the most probable recognition result. In this way, even if a decoded result has a low confidence value associated with it, it may still be accepted by the system if other checks confirm that it is a valid response. A simple Boolean approach may result in valid inputs being discounted.

An improvement to this scheme is to define a language model probability function that is called by the recogniser as each character is recognised by the system. This allows a recognition system to prune unlikely or invalid recognition string early in the recognition procedure, allowing long strings of text to be recognised efficiently. During the recognition procedure, a large number of potential results are produced by considering different combinations of recognised characters. Typically, there are a large number of potential character alternatives for each letter position, so for text of even moderate length, there are a large number of alternatives. As a result, recognition systems generally use a beam search technique, such that the n best alternatives at each letter position are considered, where n is typically between 10 and 100. Thus, the n most likely results at each position are stored, with the remainder discarded.

However, to select the n best results at each step requires validation from the language model at each step rather than after the recognition procedure has completed, otherwise high-scoring strings that are impossible or unlikely as defined by the language model may be retained while valid but lower-scoring strings are discarded. As a result, the improved language model function should be able to calculate and return a sub-string probability, so that the recogniser can combine the character classification probability with the sub-string probability at each step, and thus select the n most likely strings. This flexible approach allows almost any language model, including dictionaries and character Markov-models, to be implemented.

The following part describes how data may be extracted for various commonly used form definition formats, including HTML, XForms and PDF (Adobe Portable Document Format).

Hypertext Mark-up Language (HTML) is a standard set of mark-up symbols used to define the format of a page of text and graphics that is intended for display in a World Wide Web browser. HTML is a formal recommendation by the World Wide Web Consortium (W3C) and is defined in the W3C “HTML 4.01 Specification” of 24 Dec. 1999. XHTML, a reformulation of HTML as an XML application, is very similar to HTML and is defined in the W3C “XHTML 1.0 The Extensible HyperText Markup Language (Second Edition)” of 1 Aug. 2002, and similarly, SGML which is defined in the ISO “Information Processing—Text and office systems—Standard Generalised Markup Language (SGML)”, ISO 8879 of 1986.

Some example HTML code for a form is given below (an example of the output that this code might generate in a browser is given in FIG. 1.

<html>
<form ACTION=“cgi-bin/form.exe” METHOD=post>
<p><b>Please Enter Your Name</b></p>
<p>First Name: <INPUT TYPE=“TEXT” NAME=“FirstName”
CUSTOM=“Hello”></p>
<p>Last Name: <INPUT TYPE=“TEXT”
NAME=“LastName”></p>
<p><INPUT TYPE=“SUBMIT” NAME=“Submit”></p>
</form>
</html>

Usually, field labels associated with input fields can be easily derived from the HTML document source. Generally, field labels appear as normal text immediately before the input field definition (as shown above). In other situations, the layout of the rendered document can be analysed to determine which text labels should be associated with which input fields (for example, when a table is used for form layout). Additionally, the “name” attribute that is associated with many input elements may contain text that will allow the field type to be determined.

Standard HTML contains a number of element attributes that can be usefully used as hints to a recognition system. Some examples include:

the “maxlength” attribute of an INPUT element that can be used to limit the length of the recognised text,

the OPTION elements associated with a SELECT element that represent the set of valid input strings (which can be used as dictionary entries during recognition), and

the “rows” and “cols” attributes in a TEXTAREA element that could be used to define a character spacing guide (e.g. boxed input where each letter must be written in a separate box).

In addition to this, custom attributes can be easily added to HTML field elements (e.g. CUSTOM=“Hello”), since browsers and other systems processing a page must ignore attributes that are unknown. In this way a form designer can add custom elements to HTML source code which will only be used by recognition systems and will safely be ignored by ‘dumb’ browsers.

XFORMS is a standard form definition language defined by W3C and described in “XForms 1.0” W3C Working draft of 21 Aug. 2002. The XForm1s standard has been developed as a successor to HTML forms, and implements device independent form processing by allowing the same form to operate on desktop computers, hand-held devices, information appliances, and even paper. To achieve this, XForms ensures that, unlike HTML, data definitions are kept separate from presentation. An example of XForms code is given below. An example of the output that this code might generate in a browser is given in FIG. 2.

```
<xform>
<submitInfo action=“form.exe” method=“post”/>
</xform>
<input xform=“payment” ref=“cc”>
  <caption>Credit Card Number</caption>
</input><input xform=“payment” ref=“exp”>
  <caption>Expiration Date</caption>
</input><submit xform=“payment”>
  <caption>Submit</caption>
</submit>
```

In a similar manner to HTML, field labels can be derived from the XForms code by examining the caption element in the input field definitions. In addition to this, XForms supports input field elements similar to those described previously for HTML, including the list selection elements “<selectOne>” and “<selectMany>” and associated “<item>” elements that can be used a dictionary entries during recognition processing.

The XForms specification includes a set of data-types for field input, including date, money, number, string, time, and URI types. This information can be used by a recognition system to improve recognition accuracy. Similarly, the specification includes data attributes (e.g. currency, decimal places, integer) and validation attributes (minimum value, maximum value, pattern, range), which can be used to further improve recognition results.

Portable Document Format (PDF) is a document format defined by Adobe that has become the de-facto standard for Internet-based document distribution. Recently, Adobe has added interactive elements that allow the definition of forms for online use.

Like HTML and XForms, PDF form elements have a specific type (e.g. text, signature, combo box, list box) that defines the behaviour of the element and thus can be used as a guide for a handwriting recognition system. They also contain a field name (e.g. “/T (FirstName)”) that may contain a useful label that indicates the type of data to be entered into the field. List and combination fields contain a set of options (“/Opt [(Option1)(Option2)]”) that define the valid selection strings.

Additional field attributes include a format specifier (e.g. number, percent, date, time, zip code, phone number, social security number, etc.) and JavaScript validation code that is executed when data has been entered into the field. Custom attributes can also be easily incorporated in field definitions, as shown above (“/CUSTOM_ATTRIBUTE (HelloWorld)”).

Embodiments of the present invention may be implemented using a suitable programmed and conditioned microprocessor. Such a microprocessor may form part of a custom system, specifically designed to operate in a character recognition environment or, it may be a general purpose computer, such as a desktop PC, which is also able to perform other more general tasks.

In the light of the foregoing description, it will be clear to the ordinary skilled person that various modifications may be mode within the scope of the invention.

The present invention includes any novel feature or combination of features disclosed herein either explicitly or any generalisation thereof irrespective of whether or not it relates to the claimed invention or mitigates any or all of the problems addressed.

What is claimed is:

1. A method of interpreting data input to a form-based data entry system, including decoding data entered into a particular form field such that its information content can be determined, said information content being in a consistent machine-readable format, wherein said decoding of data includes determining one or more possible values of information content, certain pre-defined possible outcomes being given a relatively higher probability of being correct, and said pre-defined possible outcomes being dependent on the context of the particular form field.

2. The method as claimed in claim 1, wherein said decoding of data is performed contemporaneously with the data entry (online).

3. The method as claimed in claim 1, wherein said decoding of data is performed some time after the data entry (offline).

4. The method as claimed in any one of the preceding claims, wherein the data entry is effected by one or both of handwritten characters and speech.

5. The method as claimed in any one of the preceding claims, wherein the particular form field has associated with it a pre-defined dictionary of possible decoded data, said dictionary being used to constrain the decoding process.

6. The method as claimed in claim 5 wherein, certain entries in the dictionary are assigned a higher probability of being the correct decoded data.

7. The method as claimed in either of claims 5 or 6, wherein the field is a name field and the predefined dictionary includes an indication of gender associated with selected names.

8. The method as claimed in either of claims 5 or 6, wherein the field is an address field having sub-fields arranged hierarchically such that a decoded entry in a sub-field may be used to constrain an entry in another sub-field.

9. The method as claimed in either of claims 5 or 6, wherein the field is a telephone number field and is constrained such that the only valid data includes numerals only.

10. The method as claimed in any one of the preceding claims, wherein the field is a credit card number, wherein the only valid data includes a fixed number of numerals, said numerals being further verifiably by use of a checksum.

11. The method as claimed in any one of the preceding claims, wherein the field is from the set including: zip/post code; country; date; email address; and/or language.

12. The method as claimed in any one of the preceding claims, wherein the said system is implemented using one of the standardized file formats: HTML, XML, PDF and XForms.

13. The method as claimed in any one of the preceding claims, wherein a custom validation program is associated with the field, the custom validation program being executed on a possible value.

14. The method as claimed in claim 13, wherein the custom validation program is a JavaScript program.

15. The method as claimed in any one of the preceding claims, wherein a field mask is associated with the field, the field mask checking that a possible value conforms with a predefined string pattern.

16. The method as claimed in any one of the preceding claims, wherein a possible value is derived from a selection list, or combination list, involving previously recognised responses.
